(19) United States
(12) Patent Application Publication
(10) Pub. No.: US 2006/0005043 A1
(43) Pub. Date: Jan. 5, 2006

(54) Method of scanning computer virus within internet packet

(76) Inventor: Jung-Jen Hsueh, Taipei City (TW)

Correspondence Address: Jung-Jen Hsueh, 7F., No. 213, Civic Boulevard. Sec. 4, Taipei, 105, TW

(21) Appl. No.: 10/884,472

(22) Filed: Jul. 3, 2004

(51) Int. Cl. H04L 9/32

(52) U.S. Cl. 713/188

(57) ABSTRACT

Disclosed is a method of scanning computer virus within internet packets, where a TSR anti-virus program that is stay-resident in the internet equipment at user's site, which anti-virus program is capable of scanning the packets sent from and received by the internet equipment at user's site; the packet is transmitted in a normal manner if the packet is not infected with virus, whereas if the packet is infected with virus, the virus within the packet is modified and then continues to be transmitted, or the packet is rejected so as to terminate the transmission service, thereby completely shielding the user's computer system from internet data infected with virus.

### FIELD OF INVENTION

The invention relates to a method of scanning computer virus within internet packets, to be implemented in internet equipment at user's site for scanning packets sent from and received by the user's internet equipment.

### Background

The commercially available anti-virus programs are designed to scan virus in the form of files. Thus, when a computer user utilizes internet to receive or transmit information, most of the programs would take on a passive, defensive mode while encountering virus in the form of files. Even if the computer user has installed anti-virus programs, it is still likely for the virus to infect the computer if the anti-virus programs are not normally activated, or updated to the latest versions.

### SUMMARY OF INVENTION

In view of the above, this invention discloses a method of scanning computer virus within internet packets, where the method uses a TSR anti-virus program that is stay-resident in the internet equipment at user's site, which anti-virus program is capable of scanning the packets sent from and received by the internet equipment at user's site. The feature that distinguish the method of this invention from that of the conventional scanning method by detecting and removing computer virus after the computer virus has entered the user's computer system, such that the computer virus can be eliminated prior to turning into a file.

Thus, it is an objective of this invention is to provide a method of scanning computer virus within internet packets, where detection and elimination of computer virus is targeted at the packets so as to prevent the computer virus from entering the user's computer system in the form of a file.

To achieve the above objective, this invention discloses a method of scanning computer virus within an internet packet, to be implemented in internet equipment at user's site, the method comprising the steps of:

(a) maintaining a TSR anti-virus program in a hierarchy of the internet equipment at user's site, the hierarchy is selected from one of the followings:

the network access layer within TCP/IP protocol;

the network layer within TCP/IP protocol;

the transport layer within TCP/IP protocol;

the application layer within TCP/IP protocol;

the data link layer within OSI standards;

the network layer within OSI standards;

the transport layer within OSI standards;

the session layer within OSI standards;

the presentation layer within OSI standards; and

the application layer of OSI standards;

(b) scanning the packet sent from or received by the user's internet equipment;

transmitting the packet if the packet is not infected with virus;

carrying out any of the following measures if the packet is infected with virus:

I. modifying the virus, by
(i) modifying the virus within the packet; and
(ii) continuing to transmit the modified packet;

II. rejecting the packet and interrupting the transmission service,

thereby preventing computers within the same domain from receiving the packet infected with virus and ensuring that the packet sent from the domain is not infected with computer virus.

### BRIEF DESCRIPTION OF THE DRAWINGS

These and other modifications and advantages will become even more apparent from the following detailed description of a preferred embodiment of the invention and from the drawings in which:

FIG. 1 is a schematic view of an internet configuration.

FIG. 2 illustrates the hierarchy of TCP/IP protocol.

FIG. 3 is a first schematic view illustrating data transmission within TCP/IP protocol.

FIG. 4 is a second schematic view illustrating data transmission within TCP/IP protocol.

FIG. 5 is a first schematic view illustrating the flow chart of this invention.

FIG. 6 is a second schematic view illustrating the flow chart of this invention.

FIG. 7 is a third schematic view illustrating the flow chart of this invention.

FIG. 8 is a first schematic view illustrating an alternative flow chart of this invention.

FIG. 9 is a second schematic view illustrating the alternative flow chart of this invention.

### DETAILED DESCRIPTION OF THE INVENTION (PREFERRED EMBODIMENTS)

Packet and Hierarchy and Communication Protocol

The means for PCs to share resources with other PCs includes hardware, such as hosts, gateways and internet transmission lines and software, such as TCP/IP protocol. TCP/IP protocol is suited to a variety of internet configuration, such as Ethernets, token rings and X.25 networks, to allow compatibility of the worldwide network communication and to allow inter-communication among different domains of different internet configurations, which not only brings about convenient internet communication, but also serves a faster and extensive channel for spreading computer virus.

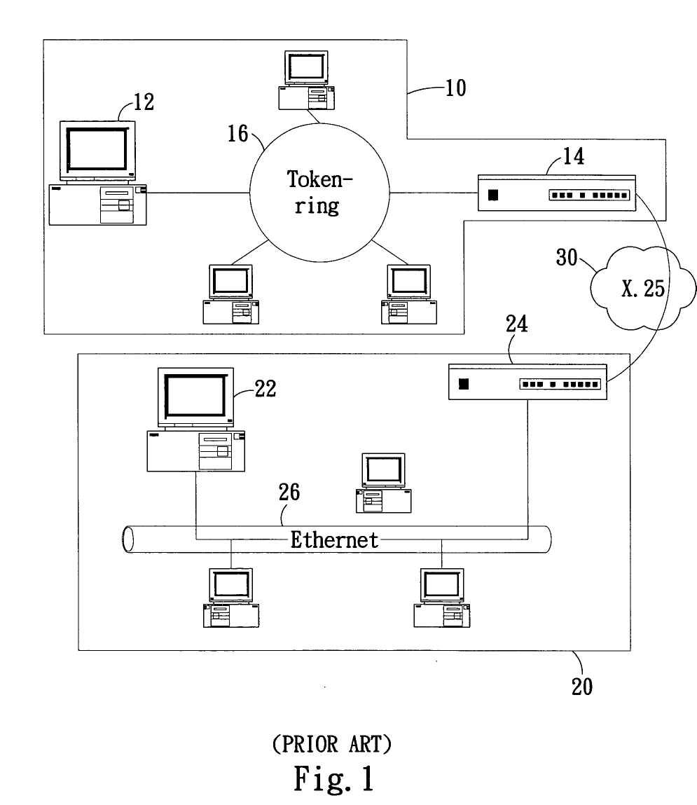

FIG. 1 illustrates a schematic view of an internet configuration, where an internet is constructed by different internet configurations through TCP/IP protocol, wherein an intranet 10 is connected to a host via a token ring 16, a local area network (LAN) 20 is connected to a different host via an Ethernet 26, and the intranet 10 and LAN 20 are connected to an X.25 network via a gateway 14 and a gateway 24, respectively. Assumed that a file is to be transmitted from a first user 12 of the token ring 16 to a second user's site 22 of the Ethernet 26, the file needs to sequentially pass through the token ring 16, X.25 network 30 and Ethernet 26, wherein the internet equipment at user's site as used mainly includes hosts (12, 22) and gateways (14, 24).

Because the communication among different domains are achieved by software and hardware configurations, to ensure that computer system at different user's sites can be inter-linked, standards are formulated by the industry to be followed by software and hardware manufactures, such as OSI standards and TCP/IP protocol. Table 1 illustrates the corresponding relationship between the hierarchies of OSI standards and TCP/IP protocol.

TABLE 1

| OSI standards | TCP/IP protocol |
|---|---|
| Application layer | Application layer |
| Presentation layer | transport layer |
| Session layer | |
| Transport layer | |
| Network layer | Network layer |
| Data link layer | Network access layer |
| Physical layer | |

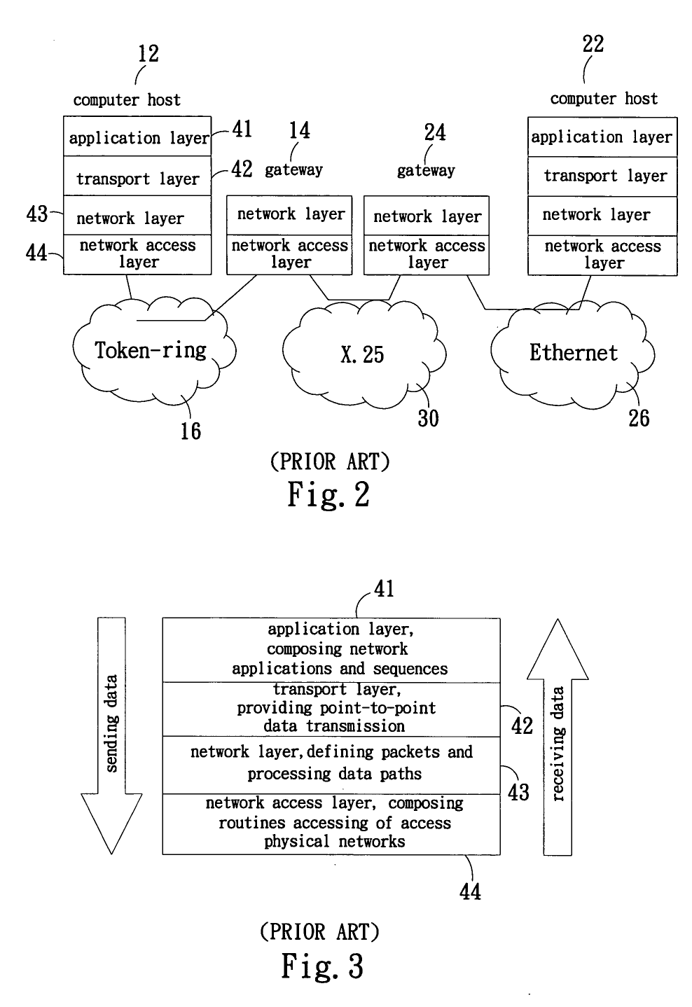

The hierarchy of TCP/IP protocol shown in FIG. 2 explains the communication mechanism among different domains. As shown, when link communication is carried out among different domains, for TCP/IP protocol, the datagram transmitted by the hosts (12, 22) must pass through an application layer 41, a transport layer 42, a network layer 43 and a network access layer 44. The datagram transmitted by the gateways (14, 24) must pass through a network layer 43 and a network access layer 44. Thus, the use of internet to transmit data at least requires the network layer 43 and network access layer 44 within TCP/IP protocol. The formation of the datagram is attributed to the fact that different internet configuration have each defined the Maximum Transmission Unit (MTU), such that the packets to be transmitted within a domain needs to be divided into multiple datagram, which needs to be adjusted in accordance with that different MTU defined by the different internet configurations that the packets pass through.

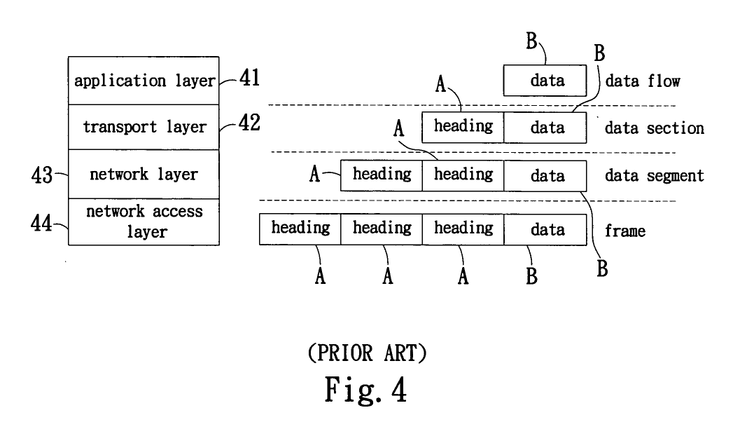

With reference to FIG. 3, for TCP/IP protocol, when a user's site transmits data, that data needs to sequentially pass through the application layer 41, transport layer 42, network layer 43 and network access layer 44. On the other hand, when another user's site receives data, the data needs to sequentially pass through the network access layer 44, network layer 43, transport layer 42 and application layer 41, that is, in a reverse order. With reference to FIG. 4, in the process of sending internet data, a heading A would be added to the beginning of data B for each layer that the data passes through. On the other hand, in the process of receiving internet data, the heading A would be deleted for each layer that that data passes through.

It is thus known from that above that the process of data transmission through the internet requires the division of a file into multiple datagram. The datagram would need to pass through the network layer, network access layer, transport layer and application layer when the process adopts TCP/IP protocol, and similarly passes through the data link layer, network layer, transport layer, session layer, presentation layer, application layer and physical layer when the process adopts OSI standards.

According to this invention, the TSR anti-virus program is stay-resident in the hierarchy of the internet equipment at user's site (note: except for the physical layer because it represents the hardware components), such that the program is capable of detecting and eliminating the computer virus in the form of datagram so as to prevent invasion of the computer virus into the user's computer system in the form of a file.

Virus Scanning of Internet Packet

For TCP/IP protocol, if the TSR anti-virus program stay-resident in the network access layer of the computer equipment at user's site, when the hierarchy has accessed datagram, the program would proceed to analyze the information recorded in the heading and scan the data. Upon scanning, the datagram would be let through. Because the virus file would also be divided into several diagrams in the process of network transmission, several datagram must be scanned in the process of scanning virus in order to affirm whether a virus file is attached to a certain service (HTTP, FTP, SMTP, or POP3. . . ).

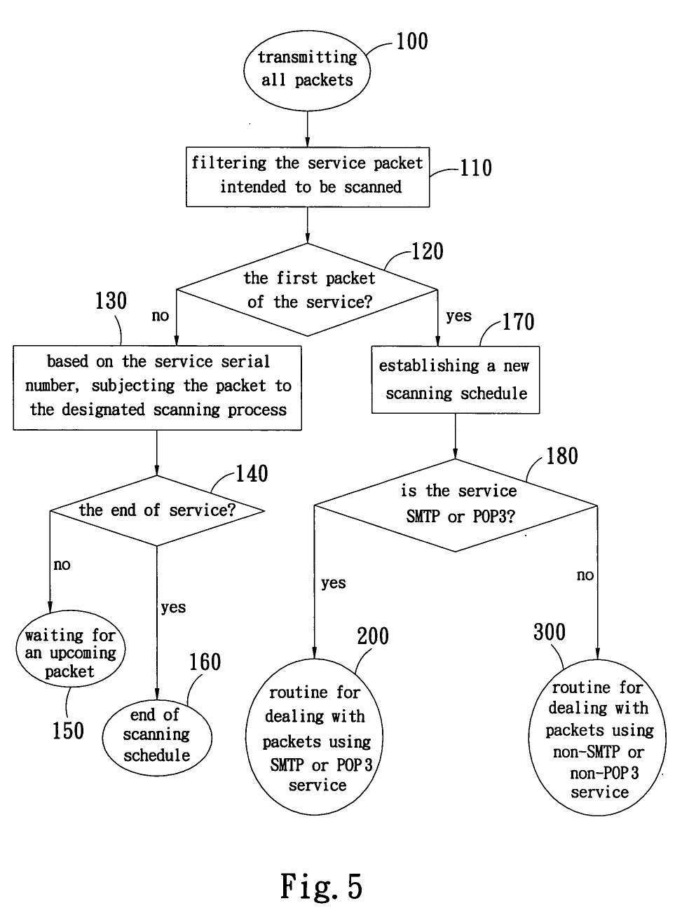

When a virus file is found to be attached to a certain service, the part containing the virus is then subjected to cleaning, such replacing the virus part with “0.” The cleaned packet is then transmitted into or out of the domain. As such, the virus file can be cleaned from each of the datagram without affecting the original transmission direction of TCP/IP protocol. The detailed process is as shown in FIGS. 5, 6 and 7.

With reference to FIG. 5, after all packets 100 have been transmitted, the program would filter the service packet intended to be scanned 110. The system would determine whether the packet under scanning is the first packet of the service 120. If negative, the packet is subjected to the designated scanning process 130. The step of determining of whether it is the end of service 140 determines whether the program should wait for an upcoming packet 150 or end the scanning schedule 160. In step 120, if the packet is the first packet of the service, a new scanning schedule is established 170. The program would then determine whether the service is SMTP or POP3 service 180 to determine whether the program should enter the routine for dealing with packets using SMTP or POP3 service 200 or that at packets using non-SMTP or non-POP3 service 300.

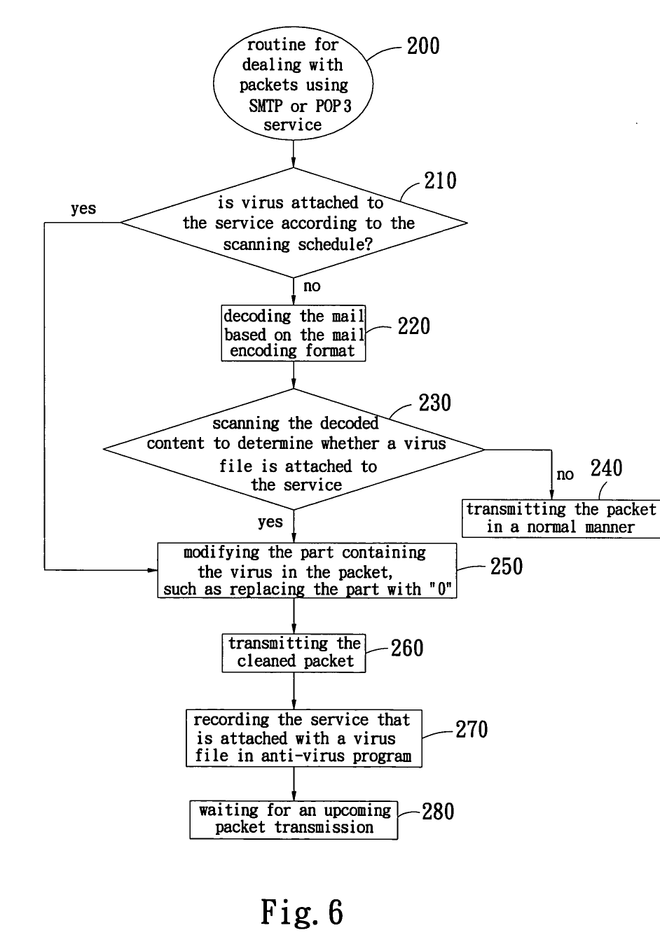

In FIG. 6, if the routine of for dealing with packets using SMTP or POP3 service is invoked, the program would determine whether virus is attached to the service according to the scanning schedule 210. If negative, the program would decode the mail based on the mail encoding format 220, and then scan the decoded content to determine whether a virus file is attached to the service 230. If negative, the packet that is not attached with a virus file is transmitted in a normal manner 240; if positive, the program would modify the part containing the virus in the packet 250, such as replacing the part with “0,” and then transmit the cleaned packet 260, which is followed by recording the service that is attached with a virus file in anti-virus program 270 and waiting for an upcoming packet transmission 280 upon recording.

In the step of determining whether virus is attached to the service according to the scanning schedule 210, if the prior packets of the same service have been determined to be attached with virus, the system would directly jump to step 250 to modify the part containing the virus in the packet.

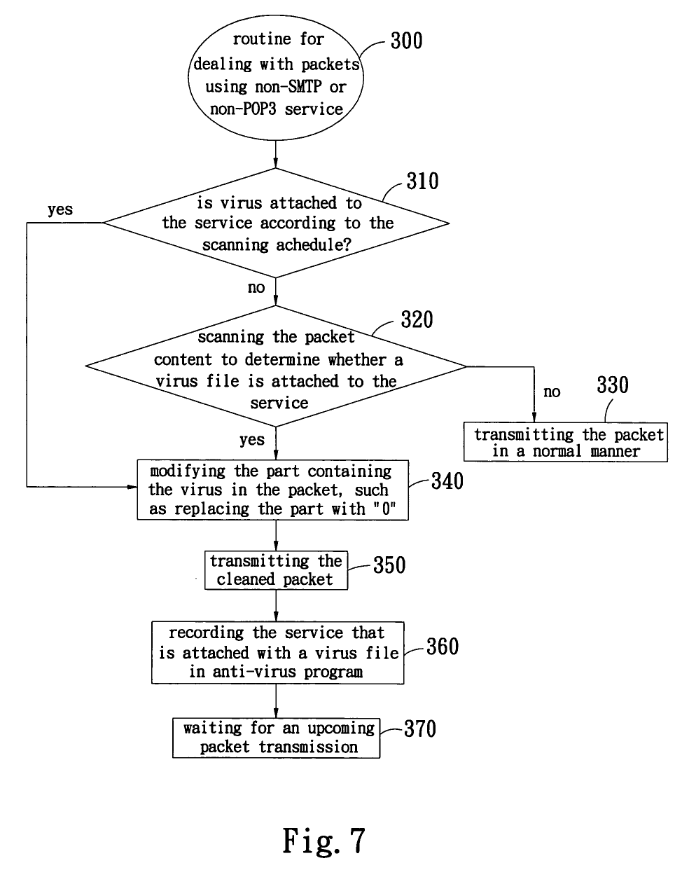

In FIG. 7, if the routine of for dealing with packets using non-SMTP or non-POP3 service is invoked, the program would determine whether virus is attached to the service according to the scanning schedule 310. If negative, the program would scan the packet content to determine whether a virus file is attached to the service 320. If negative, the packet that is not attached with a virus file is transmitted in a normal manner 330; if positive, the program would modify the part containing the virus in the packet 340, such as replacing the part with “0,” and then transmit the cleaned packet 350, which is followed by recording the service that is attached with a virus file in anti-virus program 360 and waiting for an upcoming packet transmission 370 upon recording.

In the step of determining whether virus is attached to the service according to the scanning schedule 310, if the prior packets of the same service have been determined to be attached with virus, the system would directly jump to step 340 to modify the part containing the virus in the packet.

According to this invention, the process flow in the method may further includes the step of making a log recording the scanning results, wherein the log recording the scanning results contains schedule serial numbers, service serial numbers, service attributes and whether infection is found, as shown in Table 2.

TABLE 2

| Schedule | Service | | Whether virus |
|---|---|---|---|
| Serial No. | Serial No. | Service Attributes | infection is detected? |
| #### | #### | http, ftp, smtp, pop3 . . . | Yes, No |

The above embodiment is exemplified by the network access layer within TCP/IP protocol to explain the location for maintaining the TSR anti-virus program of this invention. In actual applications, the program may be stay-resident in any of the network layer, transport layer and application layer within TCP/IP protocol. On the other hand, if this invention is applied in OSI standards, the TSR anti-virus program may be stay-resident in any of the data link layer, network layer, transport layer, session layer, presentation layer and application layer.

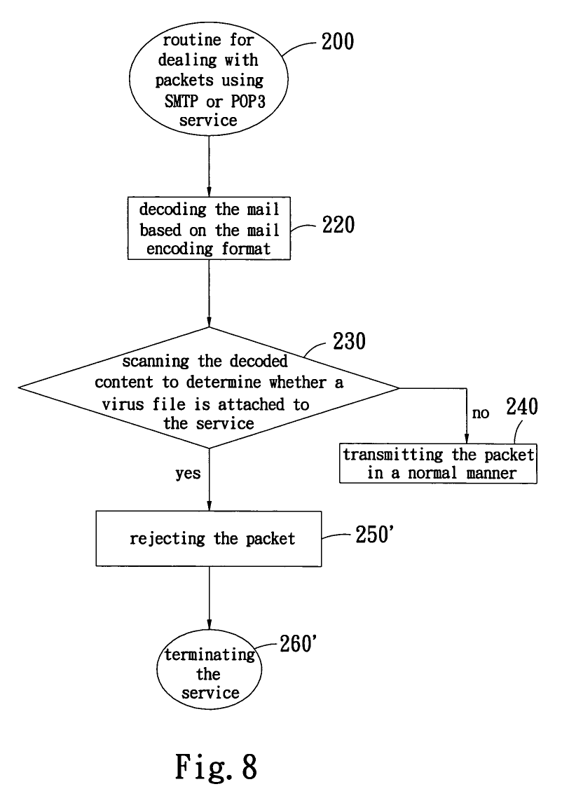

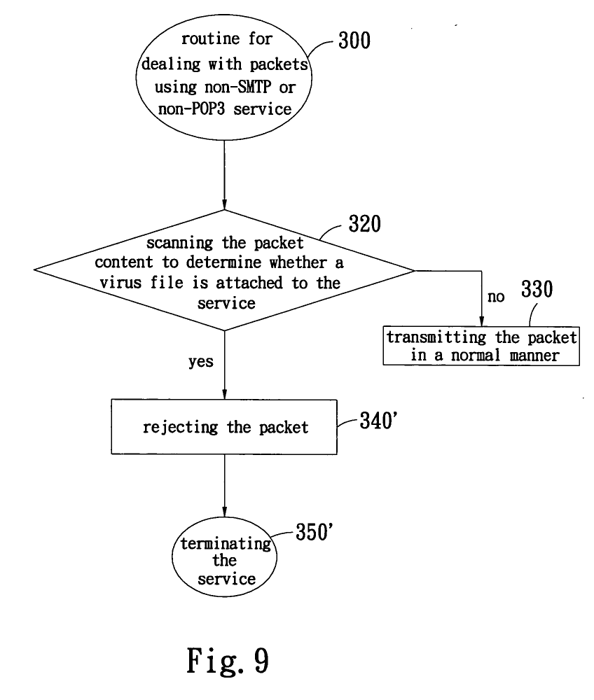

In addition, whether system employing this invention has detected that a packet under scanning has been infected with virus, the packet may be directly rejected to interrupt the transmission service, as shown in FIGS. 8 and 9, which illustrate the routines for dealing with packets using SMTP/POP3 and non-SMTP/non-POP3 services, respectively. The differences between this alternative embodiment and the prior embodiment reside in that, after the system has detected that a packet has been infected with virus, the program would directly reject the packet (250′, 340′) and terminate the service (260′, 350′).

The location for maintaining the TSR anti-virus program is dependent on the internet equipment at user's site. For TCP/IP protocol, if the TSR anti-virus program is stay-resident in the internet gateway, the program can only be stay-resident in any of the network access layer and network layer because the internet gateway is solely constructed of these two layers.

Accordingly, the method of scanning computer virus within internet packet of this invention maintains a TSR anti-virus program in the hierarchy of the internet equipment at user's site, wherein the hierarchy is selected from any of the network access layer, the network layer, the transport layer, and the application layer within TCP/IP protocol, or any of the data link layer, the network layer, the transport layer, the session layer, the presentation layer, and the application layer of OSI standards. Thus, this invention is capable of scanning the packet sent from or received by the user's internet equipment; the packet is transmitted in a normal manner if the packet is not infected with virus. If the packet is infected with virus, the virus within the packet is modified and then continues to be transmitted or the packet is rejected so as to terminate the transmission service, thereby completely shielding the user's computer system from internet data infected with virus. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A method of scanning computer virus within an internet packet, to be implemented in internet equipment at user's site, the method comprising the steps of:
(a) maintaining a TSR anti-virus program in a hierarchy of the internet equipment at user's site;
(b) scanning the packet sent from or received by the user's internet equipment;
transmitting the packet if the packet is not infected with virus;
carrying out any of the following measures if the packet is infected with virus:
I. modifying the virus, by
(i) modifying the virus within the packet; and
(ii) continuing to transmit the modified packet;
thereby preventing computers within the same domain from receiving the packet infected with virus and ensuring that the packet sent from the domain is not infected with computer virus.

2. The method of scanning computer virus within an internet packet of claim 1, wherein the hierarchy is selected from one of the followings: the network access layer within TCP/IP protocol; the network layer within TCP/IP protocol; the transport layer within TCP/IP protocol; and the application layer within TCP/IP protocol.

3. The method of scanning computer virus within an internet packet of claim 1, wherein the hierarchy is selected from one of the followings: the data link layer within OSI standards; the network layer within OSI standards; the transport layer within OSI standards; the session layer within OSI standards; the presentation layer within OSI standards; and the application layer of OSI standards.

4. The method of scanning computer virus within an internet packet of claim 1, wherein the internet equipment at user's site is selected from one of the followings: host and internet gateway.

5. The method of scanning computer virus within an internet packet of claim 1, wherein in the step of scanning the packet sent from or received by the user's internet equipment, if the packet is infected with virus, the virus within the packet is modified by filling in one of the following marks: digits and symbols.

6. The method of scanning computer virus within an internet packet of claim 1, further comprising the step of: making a log recording the scanning results, wherein the log recording the scanning results contains schedule serial numbers, service serial numbers, service attributes and whether virus infection is detected.

7. A method of scanning computer virus within an internet packet, to be implemented in internet equipment at user's site, the method comprising the steps of:
(a) maintaining a TSR anti-virus program in a hierarchy of the internet equipment at user's site;
(b) scanning the packet sent from or received by the user's internet equipment;
transmitting the packet if the packet is not infected with virus;
rejecting the packet if the packet is infected with virus:
thereby preventing computers within the same domain from receiving the packet infected with virus and ensuring that the packet sent from the domain is not infected with computer virus.

8. The method of scanning computer virus within an internet packet of claim 7, wherein the hierarchy is selected from one of the followings: the network access layer within TCP/IP protocol; the network layer within TCP/IP protocol; the transport layer within TCP/IP protocol; and the application layer within TCP/IP protocol.

9. The method of scanning computer virus within an internet packet of claim 7, wherein the hierarchy is selected from one of the followings: the data link layer within OSI standards; the network layer within OSI standards; the transport layer within OSI standards; the session layer within OSI standards; the presentation layer within OSI standards; and the application layer of OSI standards.

10. The method of scanning computer virus within an internet packet of claim 7, wherein the internet equipment at user's site is selected from one of the followings: host and internet gateway.

11. The method of scanning computer virus within an internet packet of claim 7, further comprising the step of: making a log recording the scanning results, wherein the log recording the scanning results contains schedule serial numbers, service serial numbers, service attributes and whether infection is found.
